(19) United States
(12) Patent Application Publication
(10) Pub. No.: US 2004/0136383 A1
(43) Pub. Date: Jul. 15, 2004

(54) Communication device and transport system

(75) Inventor: Michio Masuda, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/742,909

(22) Filed: Dec. 23, 2003

(30) Foreign Application Priority Data
Dec. 25, 2002 (JP) 2002-374792

(51) Int. Cl. H04L 12/56

(52) U.S. Cl. 370/400; 370/396

(57) ABSTRACT

A client line accommodation unit for accommodating a variety of transmission data on a client-by-client basis comprises a path switch for performing a switching operation. A plurality of the client line accommodation units are interconnected in a mesh configuration through the path switches included therein to realize a small-scale path crossing connect device. On the other hand, a plurality of the client line accommodation units may be interconnected in a fixed manner through the path switches included therein to realize a service multiplexer device. In addition, a large-scale path switch may be added for expanding the switching capacity to realize a large-scale path crossing connect device.

### BACKGROUND OF THE INVENTION

1. Field of the Invention

The present invention relates to a communication device and a transport system for multiplexing transmission data in a variety of formats for transmission.

2. Description of the Related Art

A transport system for transmitting data in accordance with time division multiplexing through an existing network such as WAN (Wide Area Network) typically comprises a path crossing connect (XC) device for relaying, terminating, and switching transmission data; and a service multiplexer (SMX) device provided at each of the edges in the network for multiplexing and demultiplexing transmission data on a client-by-client basis.

Each of these path crossing connect device and service multiplexer device comprises a plurality of line accommodation units which serve as interfaces for accommodating transmission data in a variety of formats.

The line accommodation unit comprises, for example, an STS (Synchronous Transport Signal)/STM (Synchronous Transfer Module) interface card for accommodating transmission data in an STS format which is a multiplexing format defined in SONET (Synchronous Optical Network) and transmission data in an STM format defined in SDH (Synchronous Digital Hierarchy); a PoS interface card for accommodating transmission data in a PoS (Packet over SONET) format; an Ethernet interface card for accommodating transmission data in an Ethernet format; and the like. Details on the path crossing connect device are described, for example, in Japanese Patent laid open No. 16625/2001.

The line accommodation units provided in the service multiplexer device and the line accommodation units provided in the path crossing connect device basically have the same functions. Therefore, a significant reduction in the cost of the transport system can be expected if the service multiplexer device and path crossing connect device can be shared in the transport system.

However, since the conventional path crossing connect device comprises a switch unit for switching transmission data other than the line accommodation units, no architecture has been employed for permitting a transport system to share the service multiplexer device and path crossing connect device.

In addition, since the path crossing connect device and service multiplexer device included in the conventional transport system are not flexible enough to build a system which satisfies requested services, an increase in the system cost is problematic particularly when a small scale transport system is built.

### SUMMARY OF THE INVENTION

It is therefore an object of the present invention to provide a transport system which can be flexibly built at a low cost in accordance with the scale of a particular network associated therewith and with services provided thereby.

To achieve the above object, in the present invention, a line accommodation unit for accommodating a variety of transmission data in a client-by-client basis is provided with a path switch for performing a switching operation for every predetermined unit of data, and a plurality of the line accommodation units are interconnected through the path switches included therein in a mesh configuration. Since the line accommodation units thus configured can be used as a small-scale path crossing connect device, a small-scale transport system can be built only by providing the line accommodation units in a communication device.

In another aspect, a line accommodation unit for accommodating a variety of transmission data on a client-by-client basis is provided with a path switch for performing a switching operation for every predetermined unit of data, and a plurality of the line accommodation units are interconnected in a fixed manner through the path switches included therein. The line accommodation units thus configured can be used as a service multiplexer device. Further, a multiplicity of the line accommodation units are provided, with a large-scale path switch added for expanding the switching capacity, to build a large-scale path crossing connect device.

As appreciated from the foregoing, since the circuit configuration of the communication device according to the present invention can be used in common by the service multiplexer device and path crossing connect device, a flexible transport system can be realized in accordance with a particular scale and services provided thereby at a low cost. In addition, a large-scale transport system can be built at a low cost only by adding a large-scale path switch without replacing the line accommodation units.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram illustrating an exemplary configuration of a transport system which employs a communication device according to the present invention;

FIG. 2 is a block diagram illustrating the configuration of a first embodiment of the communication device according to the present invention;

FIG. 3 is a schematic diagram illustrating the configuration of a path switch shown in FIG. 2;

FIG. 4 is a block diagram illustrating the configuration of a second embodiment of the communication device according to the present invention;

FIG. 5 is a block diagram illustrating the configuration of a third embodiment of the communication device according to the present invention;

FIG. 6 is a schematic diagram illustrating the configuration of a path switch shown in FIG. 5;

FIG. 7 is a block diagram illustrating the configuration of a fourth embodiment of the communication device according to the present invention; and

FIG. 8 is a schematic diagram illustrating the configuration of the path switch shown in FIG. 7.

### DETAILED DESCRIPTION OF THE PREFERRED EMBODIMENTS

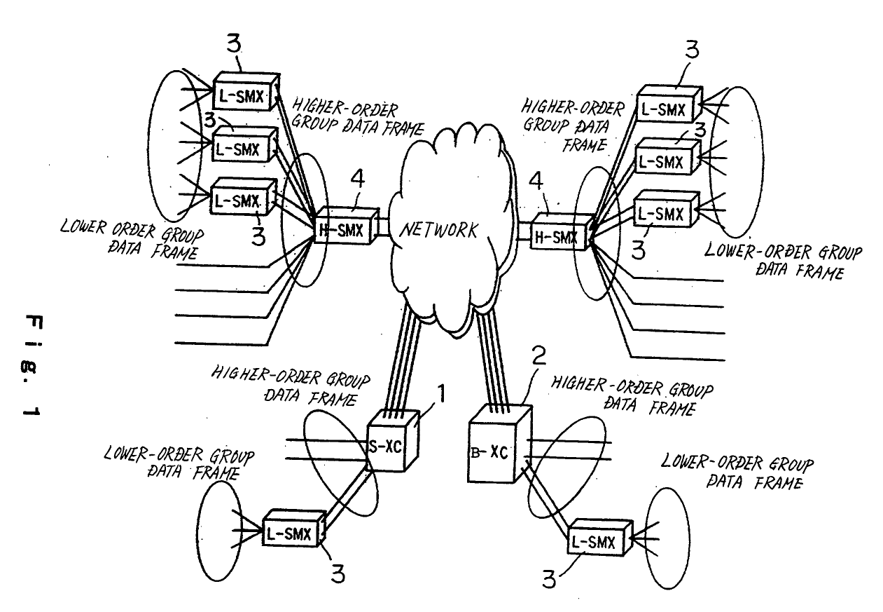

FIG. 1 is a block diagram illustrating an exemplary configuration of a transport system which employs a communication device according to the present invention.

As illustrated in FIG. 1, a transport system which can be realized by the present invention comprises a path crossing connect device implemented, for example, by small-scale path crossing connect (S-XC) device 1 and large-scale path crossing connect (B-XC) device 2; and a service multiplexer device implemented, for example, by low-speed service multiplexer (L-SMX) device 3 and high-speed service multiplexer (H-SMX) device 4.

Small-scale path crossing connect device 1 is a small-size, light-weight, low power consumption, and space saving path crossing connect device for performing switching operations in small capacities, and a relatively small transport system can be built only with small-scale path crossing connect device 1. Large-scale path crossing device 2 in turn is a path crossing connect device which is the core of a large-scale transport system for performing switching operations in large capacities, and is mainly deployed in official facilities and central hubs.

Service multiplexer devices may be classified into low-speed service multiplexer device 3 and high-speed service multiplexer device 4 in accordance with the line speed. Low-speed service multiplexer 3 executes multiplexing and demultiplexing for a lower-order group data frame which multiplexes a relatively small number of transmission data, while high-speed service multiplexer device 4 executes multiplexing and demultiplexing for a higher-order group data frame which multiplexes a large number of transmission data. These service multiplexer devices can be installed as well in the premises of a user.

In the present invention, small-scale path crossing connect device 1 is implemented by providing a line accommodation unit with a small-capacity switch unit which comprises a 1:n distributor circuit for distributing received data to n other line accommodation units (n is a positive integer); and an n:1 selector circuit for selecting and delivering specified data from received data from the n other line accommodation units. On the other hand, for building a large-scale transport system, large-scale path crossing connect device 2 is implemented by additionally installing the line accommodation units having the small-capacity switch and adding a large-capacity switch, as before, to expand the switching capacity. Further, low-speed service multiplexer device 3 and high-speed service multiplexer 4 are implemented by fixing physical connections or line connections of the small-capacity switch units included in the line accommodation units.

In summary, the present invention proposes a communication device which can be used in common by small-scale path crossing connect device 1, large-scale path crossing connect device 2, low-speed service multiplexer device 3, and high-speed service multiplexer device 4.

(First Embodiment)

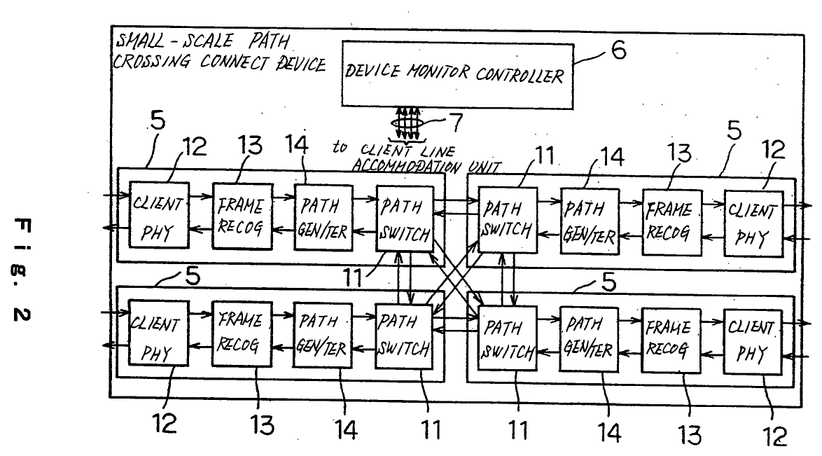

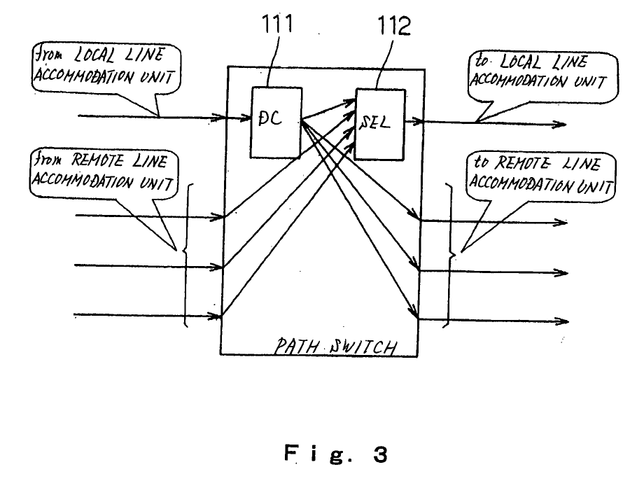

FIG. 2 is a block diagram illustrating the configuration of a first embodiment of the communication device according to the present invention, and FIG. 3 is a schematic diagram illustrating the configuration of a path switch shown in FIG. 2.

As illustrated in FIG. 2, the communication device according to the first embodiment comprises client line accommodation units 5 each for accommodating a variety of transmission data on a client-by-client basis; and device monitor controller 6 for collecting setting information and monitored items transmitted from a plurality of client line accommodation units 5, wherein client line accommodation units 5 are connected to device monitor controller 6 through monitor control bus 7. It should be noted that client line accommodation unit 5 shown in FIG. 2 is a generic name for a line accommodation unit composed of interface cards which support such communication formats as STS, STM, PoS, Ethernet, and the like.

Client line accommodation units 5 in the first embodiment each comprise path switch (small capacity switch unit) 11 for performing switching operations in units of nxSTS-3 (approximately 150 Mbps), and are interconnected through their respective path switches 11 in a mesh configuration.

Therefore, the communication device illustrated in FIG. 2 can be used as a small-scale path crossing connect device. For reference, STS-3 is a multiplexing format defined in SONET mentioned above. While the communication device illustrated in FIG. 2 has four client line accommodation units 5, the number of client line accommodation units 5 is determined in accordance with the scale of a particular transport system, and may be any number equal to or larger than two.

Each of client line accommodation units 5 comprises client terminator circuit (PHY) 12 for terminating transmission data accommodated therein on a client-by-client basis; frame recognition unit (FRAME RECOG) 13 for recognizing respective transmission units, i.e., frames of transmission data accommodated therein; path generator/terminator (PATH GEN/TER) 14 for mapping frames to corresponding channels on a path-by-path basis; and the aforementioned path switch 11 for performing switching operations in units of STS-3. Client line accommodation unit 5 is capable of bidirectional processing, so that in client line accommodation unit 5 on the transmission side, path generator/terminator 14 adds an overhead and the like to data switched by path switch 11, and the resulting data is formatted into frames by frame recognition unit 13 for transmission to the destination through client terminator circuit (PHY) 12.

As illustrated in FIG. 3, the path switch in the first embodiment comprises distributor circuit (DC) 111 for distributing (delivering a copy of) data received from line path generator/terminator (local line path generator/terminator) 14 of client line accommodation unit 5, to which the path switch itself belongs, to other client line accommodation units (remote line accommodation units) 14; and selector circuit (SEL) 112 for selecting paths specified from received data of remote line accommodation units for transmission to the local line path generator/terminator. It should be noted that the path switch illustrated in FIG. 3 is used in the small-scale path crossing connect device having four client line accommodation units 5, illustrated in FIG. 2, and therefore additionally comprises 1:4 distributor circuit 111 and 4:1 selector circuit 112 on the assumption that data is returned from one path switch to another within the small-scale path crossing connect device. Also, the path switch illustrated in FIG. 3 collectively shows functions of path switch 11 included in four client line accommodation units 5.

As described above, since the communication device of the first embodiment can be used as a small-scale path crossing connect device, a small-scale transport system can be built only with the communication device of the first embodiment.

(Second Embodiment)

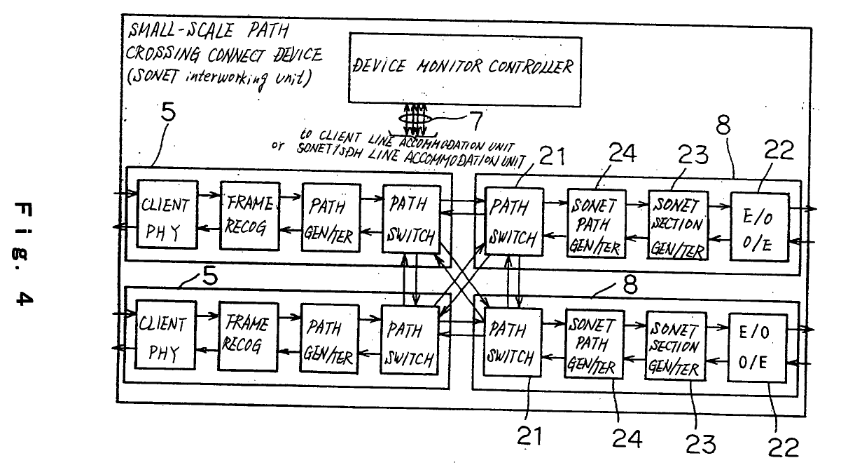

FIG. 4 is a block diagram illustrating the configuration of a second embodiment of the communication device according to the present invention.

In the communication device according to the second embodiment, two of the four client line accommodation units included in the communication device illustrated in FIG. 2 are replaced with SONET/SDH line accommodation units 8 which support the STS/STM formats.

Each of SONET/SDH line accommodation units 8 comprises a plurality of path switches 21, as is the case with the client line accommodation units shown in FIG. 2, and two client line accommodation units 5 and two SONET/SDH line accommodation units 8 are interconnected through their respective path switches in a mesh configuration.

As illustrated in FIG. 4, each of SONET/SDH line accommodation units 8 comprises opto-electric converter (E/O, O/E) 22 for accommodating or transmitting transmission data comprised of optical signals on a client-by-client basis; SONET section generator/terminator 23 for terminating accommodated transmission data; and SONET path generator/terminator 24 for mapping received data to corresponding channels, respectively.

Like client line accommodation unit 5, SONET/SDH line accommodation unit 8 is capable of bidirectional processing.

A frame alignment method employed for the mapping by SONER path generator/terminator 14 is equivalent to known virtual concatenation based multiplexing (Byre Interleave) which recognizes the next byte to a J1 byte indicated by a pointer of SONET as the beginning of an intermediate frame.

The communication device according to the second embodiment can be used as a small-scale path crossing connect device (for example, a SONET interworking unit), and therefore can be interconnected to an existing SONET/SDH network.

(Third Embodiment)

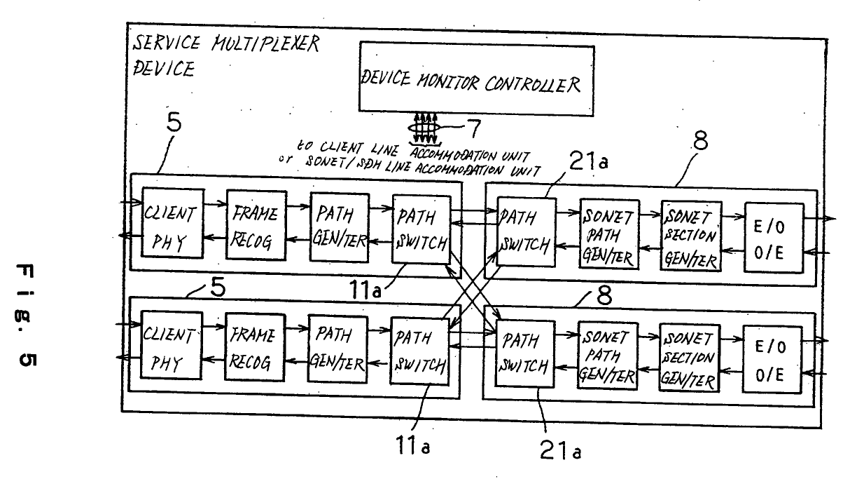

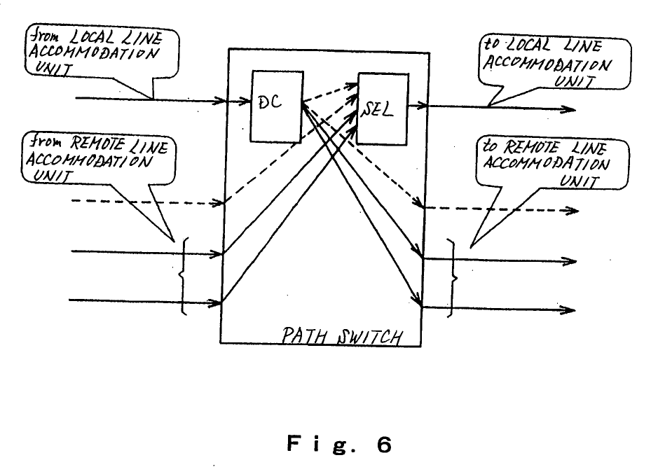

FIG. 5 is a block diagram illustrating the configuration of a third embodiment of the communication device according to the present invention, and FIG. 6 is a schematic diagram illustrating the configuration of a path switch shown in FIG. 5.

As illustrated in FIG. 5, the communication device according to the third embodiment fixes physical connections or line connections between path switches 11a included in client line accommodation units 5 and path switches 21a included in SONET/SDH line accommodation units 8 in the second embodiment illustrated in FIG. 4. In other words, the communication device according to the third embodiment operates as a service multiplexer device which has fixed connections between the client line accommodation units and SONET/SDH line accommodation units.

As illustrated in FIG. 6, the path switch of the third embodiment leaves connections indicated by broken lines unconnected in the configuration of the first embodiment illustrated in FIG. 3. As can be seen, the path switch illustrated in FIG. 6 collectively shows functions of path switch 11a included in two client line accommodation units 5 and path switches 21a included in SONET/SDH line accommodation units 8.

The communication device of the third embodiment can implement a service multiplexer device only by removing unnecessary wires, as compared with the communication device used as a path crossing connect device.

Consequently, the communication device of the third embodiment can flexibly realize a transport system at a low cost in accordance with a particular scale and services provided thereby because the circuit configuration of the communication device can be used in common by the service multiplexer device and path crossing connect device.

(Fourth Embodiment)

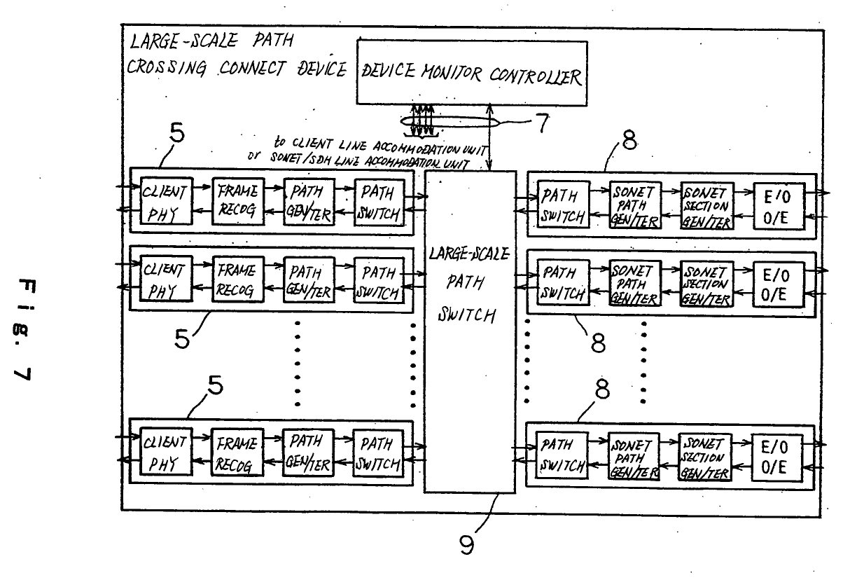

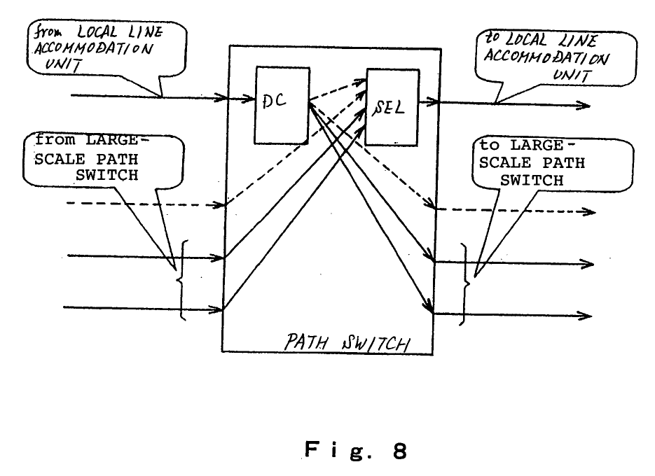

FIG. 7 is a block diagram illustrating the configuration of a fourth embodiment of the communication device according to the present invention, and FIG. 8 is a schematic diagram illustrating the configuration of a path switch shown in FIG. 7.

As illustrated in FIG. 7, the communication device according to the fourth embodiment comprises a multiplicity of client line accommodation units 5 and SONET/SDH line accommodation units 8 shown in the third embodiment, and additionally comprises large-scale path switch 9 for expanding the switching capacity. Additionally provided client line accommodation units 5, SONET/SDH line accommodation units 8, and large-scale path switch 9 are each connected to a device monitor controller through monitor control bus 7.

The path switches included in client line accommodation units 5 and SONET/SDH line accommodation units 8 have fixed physical connections or line connections with large-scale path switch 9. The connections made as shown in FIG. 8 can realize a large-scale path crossing connect device.

As illustrated in FIG. 8, in consideration of a redundant configuration of large-scale path switch 9 (duplexing is assumed in the configuration of FIG. 8), the path switch included in each line accommodation unit may only comprise a 1:2 distributor circuit and a 2:1 selector circuit.

As appreciated, when using the communication device of the present invention, a large-scale transport system can be built at a low cost because the switching capacity can be expanded only by adding the large-scale path switch without replacement of client line accommodation units 5 with SONET/SDH line accommodation units 8.

While preferred embodiments of the present invention have been described using specific terms, such description is for illustrative purposes only, and it is to be understood that changes and variations may be made without departing from the spirit or scope of the following claims.

What is claimed is:

1. A communication device for transmitting data in accordance with time division multiplexing, comprising:
a plurality of client line accommodation units each for accommodating a variety of transmission data on a client-by-client basis, said client line accommodation units each having a path switch for performing a switching operation for every predetermined unit of data, said client line accommodation units being interconnected through said path switches in a mesh configuration; and
a device monitor controller for collecting setting information and monitored items transmitted from said plurality of client line accommodation units.

2. A communication device for transmitting data in accordance with time division multiplexing, comprising:
a plurality of client line accommodation units each for accommodating a variety of transmission data on a client-by-client basis, said client line accommodation units each having a path switch for performing a switching operation for every predetermined unit of data, said client line accommodation units being interconnected through said path switches in a fixed manner; and
a device monitor controller for collecting setting information and monitored items transmitted from said plurality of client line accommodation units.

3. The communication device according to claim 2, further comprising a large-capacity switch for expanding a switching capacity.

4. The communication device according to claim 1, wherein said plurality of client line accommodation units include at least one SONET/SDH line accommodation unit for accommodating data in formats defined by SONET/SDH.

5. The communication device according to claim 2, wherein said plurality of client line accommodation units include at least one SONET/SDH line accommodation unit for accommodating data in formats defined by SONET/SDH.

6. The communication device according to claim 1, wherein said path switch comprises:
a 1:n distributor circuit for distributing received data to n other client line accommodation units, where n is a positive integer; and
an n:1 selector circuit for selecting and delivering specified data from among received data from n other client line accommodation units.

7. The communication device according to claim 2, wherein said path switch comprises:
a 1:n distributor circuit for distributing received data to n other client line accommodation units, where n is a positive integer; and
an n:1 selector circuit for selecting and delivering specified data from among received data from n other client line accommodation units.

8. A transport system for transmitting data in accordance with time division multiplexing, comprising:
a path crossing connect device for relaying, terminating, and switching transmission data, comprising:
a plurality of first client line accommodation units each for accommodating a variety of transmission data on a client-by-client basis, said first client line accommodation units each having a path switch for performing a switching operation for every predetermined unit of data, said first client line accommodation units being interconnected through said path switches in a mesh configuration; and
a first device monitor controller for collecting setting information and monitored items transmitted from said plurality of first client line accommodation units; and
a service multiplexer device disposed at each of edges in a network for multiplexing and demultiplexing transmission data on a client-by-client basis, comprising:
a plurality of second client line accommodation units each for accommodating a variety of transmission data on a client-by-client basis, said second client line accommodation units each having a path switch for performing a switching operation for every predetermined unit of data, said second client line accommodation units being interconnected through said path switches in a fixed manner; and
a second device monitor controller for collecting setting information and monitored items transmitted from said plurality of second client line accommodation units.

9. A transport system for transmitting data in accordance with time division multiplexing, comprising:
a path crossing connect device for relaying, terminating, and switching transmission data, comprising:
a plurality of first client line accommodation units each for accommodating a variety of transmission data on a client-by-client basis, said first client line accommodation units each having a path switch for performing a switching operation for every predetermined unit of data, said first client line accommodation units being interconnected through said path switches in a fixed manner;
a first device monitor controller for collecting setting information and monitored items transmitted from said plurality of first client line accommodation units;
a large-capacity switch for expanding a switching capacity; and
a service multiplexer device disposed at each of edges in a network for multiplexing and demultiplexing transmission data on a client-by-client basis, comprising:
a plurality of second client line accommodation units each for accommodating a variety of transmission data on a client-by-client basis, said second client line accommodation units each having a path switch for performing a switching operation for every predetermined unit of data, said second client line accommodation units being interconnected through said path switches in a fixed manner; and
a second device monitor controller for collecting setting information and monitored items transmitted from said plurality of second client line accommodation units.
